(19) United States
(12) Patent Application Publication
(10) Pub. No.: US 2025/0083319 A1
(43) Pub. Date: Mar. 13, 2025

(54) CONTROL SYSTEM FOR MANIPULATOR, METHOD FOR CONTROLLING MANIPULATOR, AND PROGRAM

(71) Applicant: TOYOTA JIDOSHA KABUSHIKI KAISHA, Toyota-shi Aichi-ken (JP)

(72) Inventors: Takemitsu MORI, Nisshin-shi Aichi-ken (JP); Naoki MIMA, Toyota-shi Aichi-ken (JP)

(73) Assignee: TOYOTA JIDOSHA KABUSHIKI KAISHA, Toyota-shi Aichi-ken (JP)

(21) Appl. No.: 18/824,508

(22) Filed: Sep. 4, 2024

(30) Foreign Application Priority Data
Sep. 8, 2023 (JP) 2023-146459

(51) Int. Cl. B25J 9/16

(52) U.S. Cl. CPC B25J 9/1664

(57) ABSTRACT

A control system for a manipulator capable of controlling the movement of a manipulator in such a manner that, when bringing an object grasped by the manipulator into physical contact with a nearby object, the grasped object comes into contact with the nearby object with an appropriate contact force are provided. The control system for a manipulator includes an arm, and a hand attached to the arm and configured to grasp an object to be grasped. The control system includes an environment recognition unit configured to recognize a nearby object in an environment around the manipulator, an arm control unit configured to control a movement of the arm, and a hand control unit configured to predict a contact state between the grasped object and the nearby object, and adjust a grasping force of the hand according to the prediction of the contact state.

### CROSS REFERENCE TO RELATED APPLICATIONS

This application is based upon and claims the benefit of priority from Japanese patent application No. 2023-146459, filed on Sep. 8, 2023, the disclosure of which is incorporated herein in its entirety by reference.

### BACKGROUND

The present disclosure related to a control system for a manipulator, a method for a controlling manipulator, and a program.

Patent Literature 1 (Japanese Patent No. 7131323) discloses a control system for a manipulator. Regarding this system, Patent Literature 1 discloses control in which when an impact is detected in the manipulator, position control and impedance control are switched, and after the impact is avoided, the manipulator is returned to its original position.

### SUMMARY

In the technology disclosed in Patent Literature 1, there is a problem that it is not possible to control the movement of the manipulator in such a manner that, when bringing an object grasped by the manipulator into physical contact with a nearby object (e.g., placing the object grasped by the manipulator on or lifting it from a nearby object), the grasped object comes into contact with the nearby object with an appropriate contact force. Specifically, when an object (e.g., an egg) grasped by the manipulator is placed on a nearby object (e.g., the top plate of a table) by using the manipulator, if the grasped object is pressed against the nearby object while the manipulator is tightly grasping the object, an excessive contact force is transmitted from (i.e., exerted by) the nearby object to the grasped object, so that the grasped object may be damaged or the nearby object may be damaged. On the other hand, when an object (e.g., a book) grasped by the manipulator is placed on a nearby object (e.g., a bookshelf) by using the manipulator, if the grasped object is not tightly grasped, a contact force transmitted from (i.e., exerted by) the nearby object to the grasped object is not sufficient, so that the grasped object may not be successfully placed on the nearby object.

In view of the above-described problems, an object of the present disclosure is to provide a control system for a manipulator, a method for controlling a manipulator, and a program capable of controlling the movement of a manipulator in such a manner that, when bringing an object grasped by the manipulator into physical contact with a nearby object, the grasped object comes into contact with the nearby object with an appropriate contact force.

According to an aspect of the present disclosure, a control system for a manipulator including an arm, and a hand attached to the arm and configured to grasp an object to be grasped, the control system for the manipulator further including: an environment recognition unit configured to recognize a nearby object in an environment around the manipulator; an arm control unit configured to control a movement of the arm; and a hand control unit configured to predict a contact state between the grasped object and the nearby object, and adjust a grasping force of the hand according to the prediction of the contact state.

By the above-described configuration, the control system for the manipulator according to the present disclosure recognizes a nearby object by an object recognition engine, predicts a contact state between a grasped object and the nearby object, and adjusts the grasping force of the hand according to the prediction of the contact state. By doing so, the control system for the manipulator can control the movement of the manipulator in such a manner that, when the object grasped by the manipulator comes into physical contact with the nearby object, the grasped object can come into contact with the nearby object with an appropriate contact force.

Further, in the control system for the manipulator according to the present disclosure, the arm control unit controls the arm so as to place the grasped object on the nearby object, and the hand control unit determines whether or not a difference between a position coordinate of the nearby object and that of the hand grasping the grasped object becomes equal to or smaller than a predetermined threshold, and when the hand control unit determines that the difference becomes equal to or smaller than the predetermined threshold, the hand control unit adjusts a grasping force of the hand so as to be weakened from a current grasping force.

For example, when an object (e.g., an egg) grasped by the manipulator is placed on a nearby object (e.g., the top plate of a table) by using the manipulator, if the grasped object is pressed against the nearby object while the manipulator is tightly grasping the object, an excessive contact force is transmitted (i.e., exerted) from the nearby object to the grasped object, so that the grasped object may be damaged or the nearby object may be damaged. On the other hand, when the grasped object is weakly grasped, there is a risk that the grasping state by the manipulator (e.g., the position and posture in the hand) changes or the grasped object drops during the operation of the grasped object. However, in the control system for the manipulator according to the present disclosure, by the above-described configuration, the grasping force of the hand is weakened just before the grasped object comes into contact with the nearby object, and when the contact force is exerted, the grasped object moves in the hand, thus diverting the contact force, so that the contact force exerted to the grasped object and the nearby object can be reduced. Therefore, the control system can reduce the possibility that the grasped object is damaged or the nearby object is damaged. At the same time, the control system can reduce the risk that the grasping state by the manipulator changes or the grasped object drops during the operation of the grasped object.

Further, in the control system for the manipulator according to the present disclosure, the arm control unit determines a relationship between a type of the grasped object and that of the nearby object, and adjusts the grasping force of the hand based on the relationship.

For example, regarding physical contact between an object grasped by a manipulator and a nearby object, an appropriate contact force changes according to the types of these objects. In the control system for the manipulator according to the present disclosure, by the above-described configuration, it is possible to control the movement of the manipulator in such a manner that, when an object grasped by the manipulator comes into physical contact with a nearby object, the grasped object can come into contact with the nearby object with an appropriate contact force according to the types of the objects.

In the control system for the manipulator according to the present disclosure, the hand control unit predicts the contact state between the grasped object and the nearby object by using movement information of the manipulator, and adjusts the grasping force of the hand according to the prediction of the contact state.

For example, the movement information (example: a speed and a momentum of a movement) of the main part of the manipulator significantly affects the prediction of the contact state between the grasped object and the nearby object. By the above-described configuration, the control system for the manipulator according to the present disclosure can accurately predict the contact state.

A method for controlling a manipulator according to the present disclosure is a method for controlling a manipulator including an arm, and a hand attached to the arm and configured to grasp an object to be grasped, the method including: recognizing a nearby object in an environment around the manipulator; controlling a movement of the arm; and predicting a contact state between the grasped object and the nearby object, and adjusting a grasping force of the hand according to the prediction of the contact state.

By the above-described configuration, in the method for controlling a manipulator according to the present disclosure, a nearby object is recognized by an object recognition engine, and a contact state between a grasped object and the nearby object is predicted. Further, the grasping force of the hand is adjusted according to the prediction of the contact state. By doing so, in the method for controlling a manipulator according to the present disclosure, it is possible to control the movement of the manipulator in such a manner that, when the object grasped by the manipulator comes into physical contact with the nearby object, the grasped object can come into contact with the nearby object with an appropriate contact force.

A program according to the present disclosure is a program for causing a computer to control a manipulator including an arm, and a hand attached to the arm and configured to grasp an object to be grasped, the program being configured to cause the computer to: recognize a nearby object in an environment around the manipulator; control a movement of the arm; and predict a contact state between the grasped object and the nearby object, and adjust a grasping force of the hand according to the prediction of the contact state.

By the above-described configuration, by the program according to the present disclosure, a nearby object is recognized by an object recognition engine, and a contact state between a grasped object and the nearby object is predicted. Further, the grasping force of the hand is adjusted according to the prediction of the contact state. By doing so, by the program according to the present disclosure, it is possible to control the movement of the manipulator in such a manner that, when the object grasped by the manipulator comes into physical contact with the nearby object, the grasped object can come into contact with the nearby object with an appropriate contact force.

According to the present disclosure, it is possible to a control system for a manipulator, a method for controlling a manipulator, and a program capable of controlling the movement of a manipulator in such a manner that, when bringing an object grasped by the manipulator into physical contact with a nearby object, the grasped object comes into contact with the nearby object with an appropriate contact force.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an external perspective view showing an example of a configuration of a robot according to a first embodiment;

FIG. 2 is a block diagram showing an example of a configuration of a control apparatus according to the first embodiment;

FIG. 3 is a flowchart showing an example of operations performed by the control apparatus according to the first embodiment;

FIG. 4 is a schematic diagram showing an example of an operation performed by the control apparatus according to the first embodiment; and

FIG. 5 is a flowchart showing another example of operations performed by the control apparatus according to the first embodiment.

### DESCRIPTION OF EMBODIMENTS

Embodiments according to the present disclosure will be described hereinafter in detail with reference to the drawings. The same or corresponding elements are assigned the same reference numerals (or symbols), and redundant descriptions thereof will be omitted as appropriate for clarifying the descriptions.

### First Embodiment

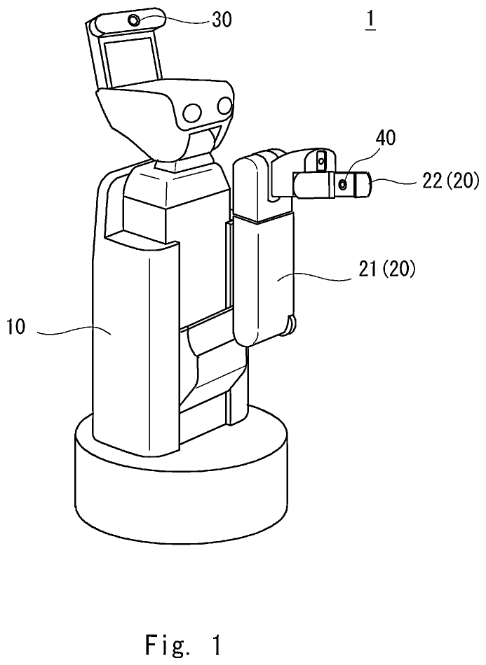

Firstly, a configuration of a robot 1 according to a first embodiment will be described with reference to FIG. 1.

FIG. 1 is an external perspective view showing an example of the configuration of the robot 1 according to the first embodiment. As shown in FIG. 1, the robot 1 includes a control apparatus 10, a manipulator 20, an environment sensor 30, and a tactile sensor 40.

The control apparatus 10 is a calculator (computer). The control apparatus 10 controls the manipulator 20, the environment sensor 30, and the tactile sensor 40. The control apparatus 10 is disposed in the body part of the robot 1. Note that the control apparatus 10 may be disposed outside the body part of the robot 1 and may perform control by communicating with the robot 1. Further, the control apparatus 10 may be a control system 10 implemented by a plurality of computers instead of being implemented by one computer.

The manipulator 20 is rotatably attached to the body part of the robot 1. The manipulator 20 is attached to the body part of the robot 1 which is equipped with a traveling mechanism, i.e., is a mobile manipulator capable of freely traveling in the environment. Note that the manipulator 20 may be a stationary arm robot installed in a factory or the like. The manipulator 20 includes an arm 21 and a hand 22. The arm 21 is a robot arm. The arm 21 includes one or a plurality of links and a joint(s) that rotatably connects two links to each other. One end of the link is connected to the body part of the robot 1 through a joint. Further, the other end of the link is connected to the hand 22 through a joint. The hand 22 is a robotic hand for grasping a target object. For example, the hand 22 is a multi-fingered hand having a plurality of fingers.

The environment sensor 30 is disposed in the head or the like of the robot 1. The environment sensor 30 measures (i.e., obtain) environment information, i.e., information about the environment around the manipulator 20. Specifically, the environment sensor 30 is a 3D (three-dimensional) depth sensor, and obtains an image including a nearby object and measures a distance to the nearby object as environment information.

The tactile sensor 40 is disposed in a grasping area of the hand 22. The tactile sensor 40 is a sensor that measures the current grasping force by which the hand 22 is currently grasping the grasped object. For example, the tactile sensor 40 is a film-type tactile sensor that measures the grasping force of the hand 22 by measuring a friction force and/or a pressure exerted in the measurement area. Further, the tactile sensor 40 is a multi-array-type tactile sensor, and may simultaneously measure a friction force and a pressure exerted to each of a plurality of points in the measurement area. By using the information about the grasping force obtained from the tactile sensor 40, it is possible to estimate, when the grasped object comes into contact with a nearby object, the contact force exerted between the grasped object and the nearby object. By collecting and analyzing data on the contact force, it is possible to predict whether or not the contact force is appropriate before the contact.

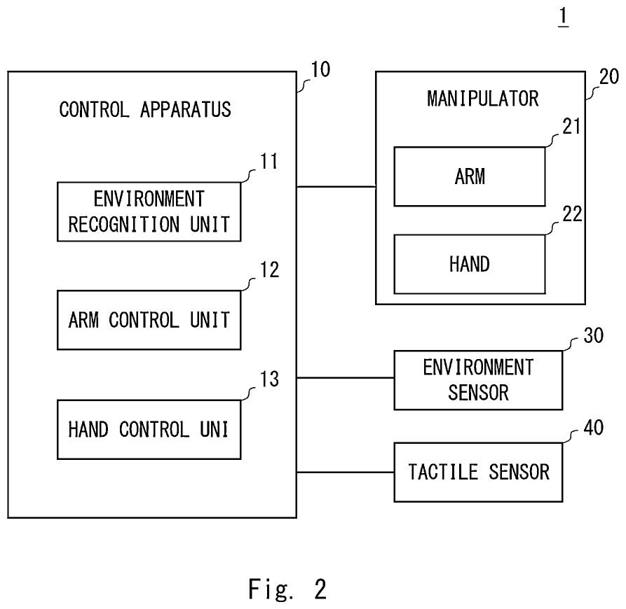

Next, a configuration of the control apparatus 10 according to the first embodiment will be described with reference to FIG. 2.

FIG. 2 is a block diagram showing an example of the configuration of the control apparatus 10 according to the first embodiment. As shown in FIG. 2, the control apparatus 10 includes an environment recognition unit 11, an arm control unit 12, and a hand control unit 13.

The environment recognition unit 11 recognizes the environment around the manipulator 20. Specifically, the environment recognition unit 11 acquires environment information from the environment sensor 30. The environment recognition unit 11 recognizes an object to be grasped by the manipulator 20 and a nearby object from the environment information by using an object recognition engine such as a deep learning model. In this process, the environment recognition unit 11 recognizes the type of the grasped object and that of the nearby object. Further, the environment recognition unit 11 recognizes the position coordinates of the nearby object in a robot coordinate system from the environment information.

The arm control unit 12 controls the movement of the arm 21 of the manipulator 20. Specifically, the arm control unit 12 determines, from among recognized nearby objects, a nearby object on which it will place the grasped object. The arm control unit 12 calculates a trajectory plan for the arm 21 so as to place the grasped object on the nearby object. Then, the arm control unit 12 controls the movement of the arm 21 so as to move the arm 21 along the calculated trajectory plan. Further, the arm control unit 12 determines, from among the recognized nearby objects, a nearby object that it will lift as the object to be grasped. The arm control unit 12 calculates a trajectory plan for the arm 21 so as to lift the object to be grasped. Then, the arm control unit 12 controls the movement of the arm 21 so as to move the arm 21 along the calculated trajectory plan. During the movement of the arm 21, the arm control unit 12 calculates the position coordinates of the tips of the hand 22 in the robot coordinate system from the joint angle(s) and the link length(s) of the arm 21.

The hand control unit 13 controls the movement of the hand 22 of the manipulator 20. Specifically, the hand control unit 13 predicts a contact state between the grasped object and the nearby object. The prediction of the contact state is the prediction of a possibility that the grasped object comes into contact with the nearby object, and/or the prediction of whether or not the grasped object is about to come into contact with the nearby object. Further, the prediction of the contact state is the prediction of the type of the grasped object and that of the nearby object, and/or the prediction as to whether or not the contact force that is transmitted (i.e., exerted) to each of these objects when these objects come into contact with each other is appropriate. Then, the hand control unit 13 performs control so as to adjust the grasping force of the hand 22 according to the prediction of the contact state. Specifically, the hand control unit 13 acquires the current grasping force of the hand 22 from the tactile sensor 40. The hand control unit 13 adjusts the current grasping force of the hand 22 so as to be weakened to a predetermined value according to the prediction of the contact state. Further, the hand control unit 13 also adjusts the current grasping force of the hand 22 so as to be increased to a predetermined value according to the prediction of the contact state. Note that the predetermined value is the value of the grasping force calculated from the pressure and/or friction force exerted in the measurement area of the tactile sensor 40. Further, in the case of simultaneous multi-point measurement, the predetermined value may be the value of the grasping force calculated from the number of measurement points in the measurement area of the tactile sensor 40.

For example, when the arm control unit 12 controls the movement of the arm 21 so as to place the grasped object on the nearby object, the hand control unit 13 performs the following process. During the movement of the arm 21, the hand control unit 13 determines whether or not a difference between the position coordinates of the nearby object and those of the tips of the hand 22 in the robot coordinate system has become equal to or smaller than a predetermined threshold. That is, the hand control unit 13 predicts a possibility that the grasped object comes into contact with the nearby object, and a possibility as to whether or not the grasped object is about to come into contact with the nearby object. When it is determined that the difference between the position coordinates of the object to be contacted and the those of the tips of the hand 22 is equal to or smaller than the predetermined threshold, the hand control unit 13 adjusts the current grasping force of the hand 22, i.e., the grasping force during the operation of the arm 21, so as to be weakened to the predetermined value. By doing so, the hand control unit 13 can reduce, by reducing the contact force, the possibility that at least one of objects is damaged even when the contact force that is transmitted to each of the objects when the objects come into contact with each other is excessive. At the same time, the hand control unit 13 can reduce, by weakening the grasping force immediately before the contact, the risk that the grasping state by the manipulator changes or the grasped object drops during the operation of the grasped object. Note that the configuration of the hand control unit 13 is not limited to the above-described configuration. For example, the hand control unit 13 may adjust, when it is determined that the difference between the position coordinates of the object to be contacted and those of the tips of the hand 22 is equal to or smaller than the predetermined threshold, the current grasping force of the hand 22 so as to be increased to the predetermined value.

Further, when the arm control unit 12 controls the movement of the arm 21 so as to place the grasped object on the nearby object, the hand control unit 13 performs the following process. The hand control unit 13 determines a relationship between the type of the grasped object and that of the nearby object. That is, the hand control unit 13 predicts the type of the grasped object and that of the nearby object, and whether or not the contact force that is transmitted to each of these objects when these objects come into contact with each other is appropriate. The hand control unit 13 adjusts the grasping force of the hand 22 based on the relationship between the type of the grasped object and that of the nearby object. For example, in the case where the grasped object is an egg and the nearby object is a table, it is predicted that the contact force that is transmitted to each of these objects is excessive and hence there is a possibility that at least one of them is damaged, so that the hand control unit 13 weakens the current grasping force of the hand 22, i.e., the grasping force during the movement of the arm 21, to a predetermined value. In contrast, in the case where the grasped object is a book and the nearby object is a bookshelf, it is predicted that the contact force that is transmitted to the objects is not sufficient and hence the grasped object cannot be successfully placed, so that the hand control unit 13 increases the current grasping force of the hand 22 to a predetermined value.

Further, in the case where the arm control unit 12 controls the movement of the arm 21 so as to lift a nearby object placed on another nearby object as the object to be grasped, the hand control unit 13 performs the following process. The hand control unit 13 determines a relationship between the type of the object to be grasped and the type of the nearby object. The hand control unit 13 adjusts the grasping force of the hand 22 based on the relationship between the type of the object to be grasped and that of the nearby object. When the object to be grasped or the nearby object on which the object to be grasped is placed is a viscous object, the contact force (e.g., tension) that is transmitted to the objects is excessive, and hence it is predicted that the object to be grasped cannot be successfully lifted. Therefore, the hand control unit 13 increases the current grasping force of the hand 22 to a predetermined value.

Further, in particular, in the case where the manipulator 20 is a mobile manipulator that can freely travel in the environment, movement information (example: a speed and a momentum of a movement) of the mobile manipulator 20 significantly affects the prediction of the contact state by the hand control unit 13. Therefore, the hand control unit 13 predicts the contact state between the object to be grasped and the nearby object by using the movement information of the manipulator 20. For example, the hand control unit 13 acquires the movement information of the manipulator 20 from the arm control unit 12. Further, when the manipulator 20 is equipped with a speed sensor (not shown), the hand control unit 13 may acquire the movement information of the manipulator 20 from the speed sensor. The hand control unit 13 adjusts the grasping force of the hand 22 according to the prediction of the contact state. Therefore, the control apparatus 10 can accurately predict the contact state between the object to be grasped and the nearby object.

Further, regarding the timing of the adjustment of the grasping force of the hand 22, if the timing of the adjustment is too early, there is a possibility that the grasping force of the object to be grasped becomes excessive (or insufficient) before the contact. Therefore, it is desirable that the timing of the adjustment of the grasping force of the hand 22 be adjusted after the contact state between the object to be grasped and the nearby object is predicted and before the hand 22 actually grasps the object to be grasped at the latest. Therefore, the hand control unit 13 adjusts the grasping force of the hand 22 a predetermined period after the timing at which the contact state is predicted. For example, when it is determined that the possibility of the collision between the grasped object and the nearby object has increased after a predetermined period has elapsed from the timing at which the contact state is predicted, the hand control unit 13 adjusts the grasping force of the hand 22. Further, when it is determined that the relative distance between the grasped object and the nearby object has become shorter after a predetermined period has elapsed from the timing at which the contact state is predicted, the hand control unit 13 adjusts the grasping force of the hand 22. Therefore, regarding the timing of the adjustment of the grasping force of the hand 22, the control apparatus 10 can reduce the possibility that when the timing of the adjustment is too early, the grasping force of the object to be grasped becomes excessive (or insufficient) before the contact.

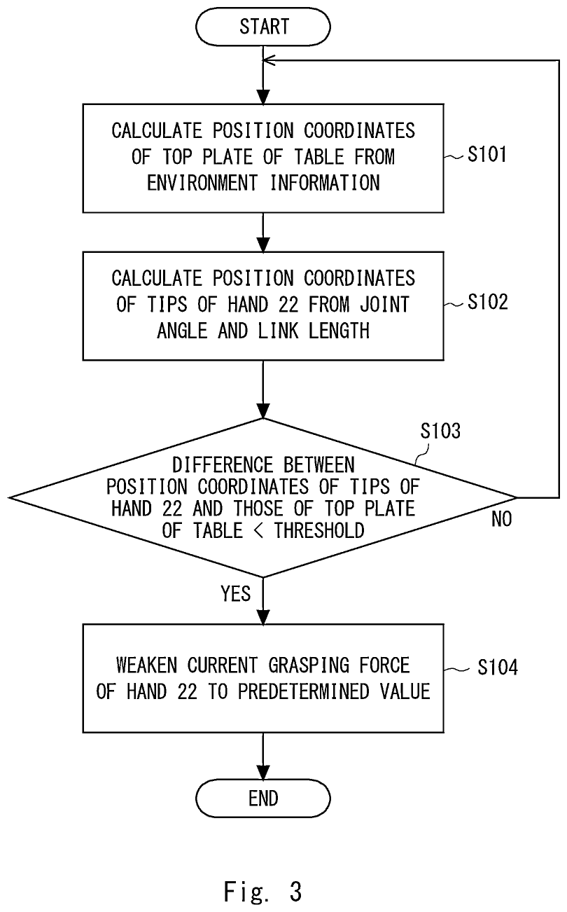

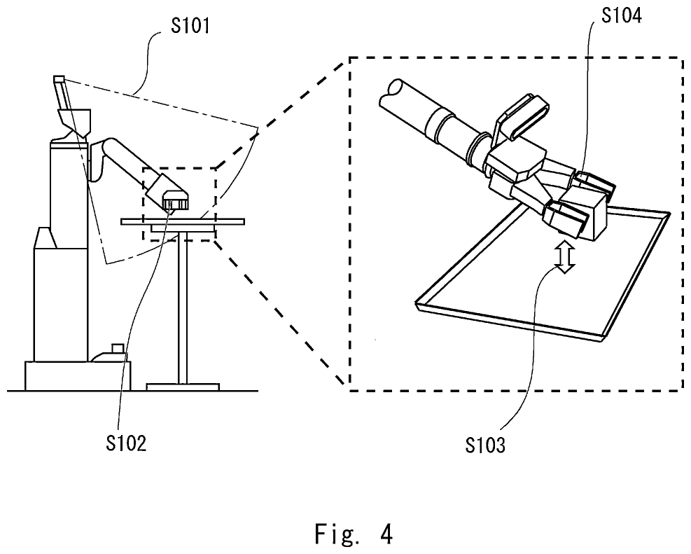

Next, an example of operations performed by the control apparatus 10 according to the first embodiment will be described with reference to FIGS. 3 and 4. FIG. 3 is a flowchart showing an example of operations performed by the control apparatus 10 according to the first embodiment. FIG. 4 is a schematic diagram showing an example of an operation performed by the control apparatus 10 according to the first embodiment.

As a premise of the following operation, it is assumed that the arm control unit 12 of the control apparatus 10 calculates a trajectory plan for the arm 21 so as to bring the grasped object into contact with a table, which is the nearby object, and then starts to control the movement of the arm 21 so as to move the arm 21 along the trajectory plan.

As shown in FIGS. 3 and 4, firstly, in a step S101, the environment recognition unit 11 of the control apparatus 10 calculates the position coordinates of the top plate of the table in the robot coordinate system from environment information acquired from the environment sensor 30.

Next, in a step S102, the arm control unit 12 calculates the position coordinates of the hand 22 in the robot coordinate system from the joint angle(s) and the link length(s) of the arm 21.

Next, in a step S103, the hand control unit 13 determines whether or not a difference between the position coordinates of the top plate of the table in the robot coordinate system and the those of the hand 22 in the robot coordinate system is equal to or shorter than a predetermined threshold. When it is determined that the difference between the position coordinates of the top plate of the table and those of the hand 22 is equal to or shorter than the predetermined threshold (Yes in Step S103), the process proceeds to a step S104. On the other hand, when it is determined that the difference between the position coordinates of the top plate of the table and those of the hand 22 is not equal to nor shorter than the predetermined threshold (No in Step S103), the process returns to the step S101.

In the step S104, the hand control unit 13 reduces the current grasping force of the hand 22, i.e., the grasping force during the movement of the arm 21, to a predetermined value. The predetermined value indicates a grasping force with which it is possible to prevent the grasped object from slipping off the hand 22.

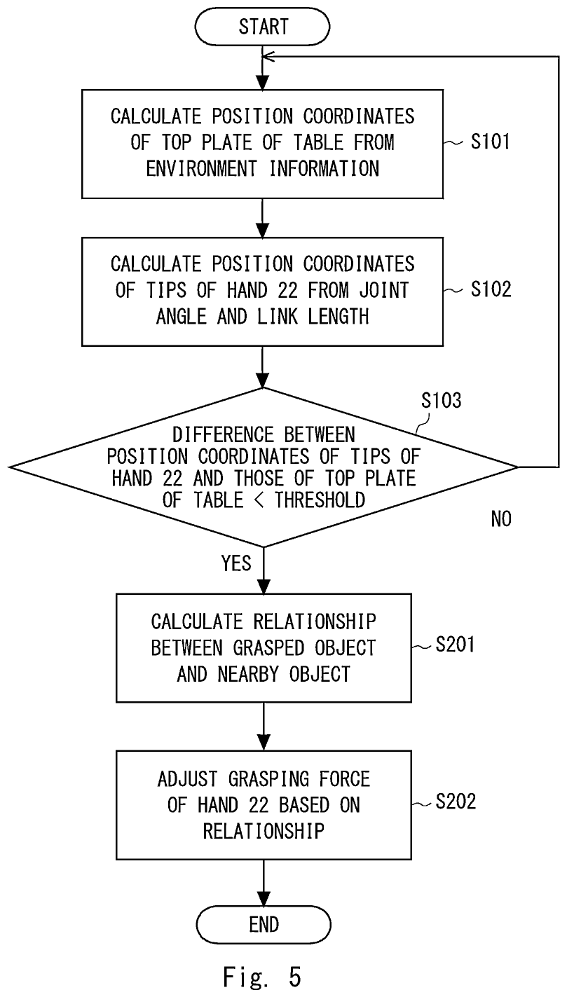

Next, another example of operations performed by the control apparatus 10 according to the first embodiment will be described with reference to FIG. 5. FIG. 5 is a flowchart showing another example of operations performed by the control apparatus 10 according to the first embodiment.

As a premise of the following operation, it is assumed that the arm control unit 12 of the control apparatus 10 calculates a trajectory plan for the arm 21 so as to bring the grasped object into contact with the nearby object, and then starts to control the movement of the arm 21 so as to move the arm 21 along the trajectory plan.

Similarly to the operations shown in FIGS. 3 and 4, the control apparatus 10 performs the above-described processes in the steps S101 to S103.

In a step S201, after performing the process corresponding to Yes in the step S103, the hand control unit 13 calculates a relationship between the type of the grasped object and that of the nearby object.

In a step S202, the hand control unit 13 adjusts the grasping force of the hand 22 based on the relationship between the type of the grasped object and that of the nearby object. For example, in the case where the grasped object is an egg and the nearby object is a table, it is predicted that the contact force that is transmitted to each of these objects is excessive and hence there is a possibility that at least one of them is damaged, so that the hand control unit 13 weakens the current grasping force of the hand 22, i.e., the grasping force during the movement of the arm 21, to a predetermined value. In contrast, in the case where the grasped object is a book and the nearby object is a bookshelf, it is predicted that the contact force that is transmitted to the objects is not sufficient and hence the grasped object cannot be successfully placed, so that the hand control unit 13 increases the current grasping force of the hand 22 to a predetermined value.

As described above, the control apparatus 10 according to the first embodiment adjusts the grasping force of the hand according to the prediction of the contact state between the grasped object and the nearby object. By doing so, the control apparatus 10 can control the movement of the manipulator in such a manner that, when bringing the object grasped by the manipulator 20 into physical contact with the nearby object, the grasped object comes into contact with the nearby object with an appropriate contact force.

Further, the control apparatus 10 according to the first embodiment weakens the current grasping force of the hand 22 to a predetermined value just before the grasped object comes into contact with the nearby object. By doing so, when the contact force is generated, the control apparatus 10 allows the grasped object to move in the hand 22, thus diverting the contact force, and by doing so, reduces the contact force exerted to the grasped object and the nearby object. Therefore, the control apparatus 10 can reduce the possibility that the grasped object is damaged or the nearby object is damaged. At the same time, the control apparatus 10 can reduce the risk that the grasping state by the manipulator changes or the grasped object drops during the operation of the grasped object.

Further, the control apparatus 10 adjusts the grasping force of the hand 22 based on the relationship between the type of the grasped object and that of the nearby object. By doing so, the control apparatus 10 can control the movement of the manipulator in such a manner that, when the object grasped by the manipulator comes into physical contact with the nearby object, the grasped object can come into contact with the nearby object with an appropriate contact force according to the types of the objects.

Further, in the comparative example, it is possible, when the grasped object is placed on the nearby object by using the manipulator, to reduce the contact force by placing the grasped object at a low speed. However, in this case, there is a aspect that the operation time increases. In contrast, since the control apparatus does not place the grasped object at a low speed, there is not such an aspect that the operation time increases.

Further, in the comparative example, there is a method in which after the grasped object receives the contact force from the nearby object, the arm is softly moved by performing feedback control. However, it is necessary to perform the feedback control at least one loop, so there is possibility that the contact force cannot be sufficiently reduced. In contrast, the control apparatus 10 can adjust the contact force by predicting the contact state between the grasped object and the nearby object, and appropriately adjusting the grasping force of the hand 22 of the manipulator 20 according to the prediction of the contact state.

The control apparatus 10 in the above-described embodiments may be formed by software, hardware, or both of them. Further, the control apparatus may be formed by one hardware device or one software program, or a plurality of hardware devices or a plurality of software programs.

Specifically, the control apparatus 10 in the above-described embodiment is formed by a computer including a processor and a memory. The processor may be, for example, a microprocessor, an MPU (Micro Processing Unit), or a CPU (Central Processing Unit). The processor may include a plurality of processors. The memory is composed of a combination of a volatile memory and a non-volatile memory. The memory may include a storage located remotely from the processor. In this case, the processor may access the memory through an I/O interface (not shown). The processor executes one or a plurality of programs including instructions for causing the computer to perform the algorithm described above using the drawings.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

Each of the drawings is merely an example to illustrate one or more embodiments. Each of the drawing is not associated with only one specific embodiment, but may be associated with one or more other embodiments. As will be understood by those skilled in the art, various features or steps described with reference to any one of the drawings may be combined with features or steps shown in one or more other drawings in order to create, for example, an embodiment that is not explicitly shown in the drawings or described in the specification. Not all of the features or steps shown in any one of the drawings to describe an embodiment are necessarily indispensable, and some features or steps may be omitted. The order of steps in any of the drawings may be changed as appropriate.

What is claimed is:

1. A control system for a manipulator comprising an arm, and a hand attached to the arm and configured to grasp an object to be grasped, the control system for the manipulator further comprising:
at least one memory storing instructions, and
at least one processor configured to execute the instructions to:
recognize a nearby object in an environment around the manipulator;
control a movement of the arm; and
predict a contact state between the grasped object and the nearby object, and adjust a grasping force of the hand according to the prediction of the contact state.

2. The control system for a manipulator according to claim 1, wherein the at least one processor is further configured to execute the instructions to:
control the arm so as to place the grasped object on the nearby object; and
determine whether or not a difference between a position coordinate of the nearby object and that of the hand grasping the grasped object becomes equal to or smaller than a predetermined threshold, and when determining that the difference becomes equal to or smaller than the predetermined threshold, adjust a grasping force of the hand so as to be weakened from a current grasping force.

3. The control system for a manipulator according to claim 1, wherein the at least one processor is further configured to execute the instructions to determine a relationship between a type of the grasped object and that of the nearby object, and adjust the grasping force of the hand based on the relationship.

4. The control system for a manipulator according to claim 1, wherein the at least one processor is further configured to execute the instructions to predict the contact state between the grasped object and the nearby object by using movement information of the manipulator, and adjust the grasping force of the hand according to the prediction of the contact state.

5. A method for controlling a manipulator comprising an arm, and a hand attached to the arm and configured to grasp an object to be grasped, the method comprising:
recognizing a nearby object in an environment around the manipulator;
controlling a movement of the arm; and
predicting a contact state between the grasped object and the nearby object, and adjusting a grasping force of the hand according to the prediction of the contact state.

6. A non-transitory computer-readable medium storing a program for causing a computer to control a manipulator comprising an arm, and a hand attached to the arm and configured to grasp an object to be grasped, the program being configured to cause the computer to:
recognize a nearby object in an environment around the manipulator;
control a movement of the arm; and
predict a contact state between the grasped object and the nearby object, and adjust a grasping force of the hand according to the prediction of the contact state.
